(19) United States
(12) Patent Application Publication
(10) Pub. No.: US 2023/0104468 A1
(43) Pub. Date: Apr. 6, 2023

(54) RANSOMWARE DETECTION IN HOST ENCRYPTED DATA ENVIRONMENT

(71) Applicant: Dell Products L.P., Hopkinton, MA (US)

(72) Inventors: Arieh Don, Newton, MA (US); Krishna Deepak Nuthakki, Bangalore (IN)

(73) Assignee: Dell Products L.P., Hopkinton, MA (US)

(21) Appl. No.: 17/494,875

(22) Filed: Oct. 6, 2021

(51) Int. Cl. G06F 21/56; G06F 21/55; G06F 21/60

(52) U.S. Cl. CPC G06F 21/565; G06F 21/554; G06F 21/602

(57) ABSTRACT

A storage node that maintains separate storage objects for storage of data for different host applications protects those storage objects against ransomware attacks by recognizing variations in data reducibility. Separate data reducibility profiles are generated for each protected storage object. In response to new data being written to one of the protected storage objects, the reducibility of the new data is compared with the data reducibility profile of the protected storage object to which the new data is being written. A mismatch indicates a ransomware attack. Counter-measures may include halting generation or overwriting of snaps, halting replication, and halting backups of the storage object, and generating ransomware attack alert messages. Decryption keys are provided to the storage node if new data is normally provided in an encrypted state.

### TECHNICAL FIELD

The subject matter of this disclosure is generally related to electronic data storage, and more particularly to detection of malicious data encryption.

### BACKGROUND

Ransomware functions by maliciously transforming client data into an unusable form using cryptography. Ransomware binaries are loaded onto a victim's computers using email, targeted attacks, or misappropriated access credentials. The ransomware binaries include search and encryption algorithms that identify and encrypt client data. The keys required to decrypt the data are maintained on a remote computer that is controlled by the attacker. Although the client data may still exist on the client's computer, the data is unusable because it cannot be decrypted without the decryption keys. The attacker ransoms the client data by demanding payment in exchange for the decryption keys. However, there is no guarantee that the keys will be provided even if the ransom is paid.

Ransomware attacks are sometimes directed at host servers running in a data center. Within a cluster, each host server may support multiple instances of a “host application” that supports a business process such as email communication, accounting, manufacturing control, or inventory control, for example, and without limitation. The host application data is maintained by one or more storage nodes such as a storage area network (SAN), network-attached storage (NAS), or converged direct-attached storage (DAS). An infected host server may cause the host application data maintained by the storage nodes to be overwritten with maliciously encrypted host application data that inhibits the proper functioning of some or all instances of the host application and thus multiple host servers. Moreover, depending on the length of time that elapses before the victim becomes aware of the ransomware attack, the maliciously encrypted data may be written to snapshots and backups that replace older, usable snapshots and backups, thereby hindering disaster recovery efforts.

### SUMMARY

An apparatus in accordance with some implementations comprises: a storage node configured to logically maintain, on a storage object, data for a host application running on a host server, the data being physically maintained on non-volatile storage media, the storage node comprising a ransomware detector configured to generate a data reducibility profile of the storage object and, responsive to receipt of a command to write new data to the storage object, calculate reducibility of the new data, compare the calculated reducibility of the new data with the data reducibility profile of the storage object, and responsive to a mismatch between the calculated reducibility of the new data and the data reducibility profile of the storage object, initiate ransomware attack counter-measures.

A method implemented by a storage node that maintains data for a host application running on a host server in accordance with some implementations comprises: generating a data reducibility profile of a storage object on which the data is stored; receiving a command to write new data to the storage object; calculating reducibility of the new data; comparing the calculated reducibility of the new data with the data reducibility profile of the storage object; and responsive to a mismatch between the calculated reducibility of the new data and the data reducibility profile of the storage object, initiating ransomware attack counter-measures.

A non-transitory computer-readable storage medium in accordance with some implementations comprises instructions that, when executed by a storage node that maintains data for a host application running on a host server, cause the storage node to implement a method comprising: generating a data reducibility profile of a storage object on which the data is stored; receiving a command to write new data to the storage object; calculating reducibility of the new data; comparing the calculated reducibility of the new data with the data reducibility profile of the storage object; and responsive to a mismatch between the calculated reducibility of the new data and the data reducibility profile of the storage object, initiating ransomware attack counter-measures.

This summary is not intended to limit the scope of the claims or the disclosure. Other aspects, features, and implementations will become apparent in view of the detailed description and figures, and all the examples, aspects, implementations, and features can be combined in any technically possible way.

### BRIEF DESCRIPTION OF THE FIGURES

FIG. 1 illustrates a storage array with a ransomware detector that recognizes maliciously encrypted host application data based on variations in data reducibility.

FIG. 2 illustrates layers of abstraction between the managed drives and the production volume of the storage array of FIG. 1.

FIG. 3 illustrates a method for recognizing maliciously encrypted host application data based on variations in data reducibility.

### DETAILED DESCRIPTION

The terminology used in this disclosure is intended to be interpreted broadly within the limits of subject matter eligibility. The terms “disk,” “drive,” and “disk drive” are used interchangeably to refer to non-volatile storage media and are not intended to refer to any specific type of non-volatile storage media. The terms “logical” and “virtual” are used to refer to features that are abstractions of other features, for example, and without limitation, abstractions of tangible features. The term “physical” is used to refer to tangible features that possibly include, but are not limited to, electronic hardware. For example, multiple virtual computers could operate simultaneously on one physical computer. The term “logic” is used to refer to special purpose physical circuit elements, firmware, software, computer instructions that are stored on a non-transitory computer-readable medium and implemented by multi-purpose tangible processors, and any combinations thereof. Aspects of the inventive concepts are described as being implemented in a data storage system that includes host servers and a storage array. Such implementations should not be viewed as limiting. Those of ordinary skill in the art will recognize that there are a wide variety of implementations of the inventive concepts in view of the teachings of the present disclosure.

Some aspects, features, and implementations described herein may include machines such as computers, electronic components, optical components, and processes such as computer-implemented procedures and steps. It will be apparent to those of ordinary skill in the art that the computer-implemented procedures and steps may be stored as computer-executable instructions on a non-transitory computer-readable medium. Furthermore, it will be understood by those of ordinary skill in the art that the computer-executable instructions may be executed on a variety of tangible processor devices, i.e., physical hardware. For practical reasons, not every step, device, and component that may be part of a computer or data storage system is described herein. Those of ordinary skill in the art will recognize such steps, devices, and components in view of the teachings of the present disclosure and the knowledge generally available to those of ordinary skill in the art. The corresponding machines and processes are therefore enabled and within the scope of the disclosure.

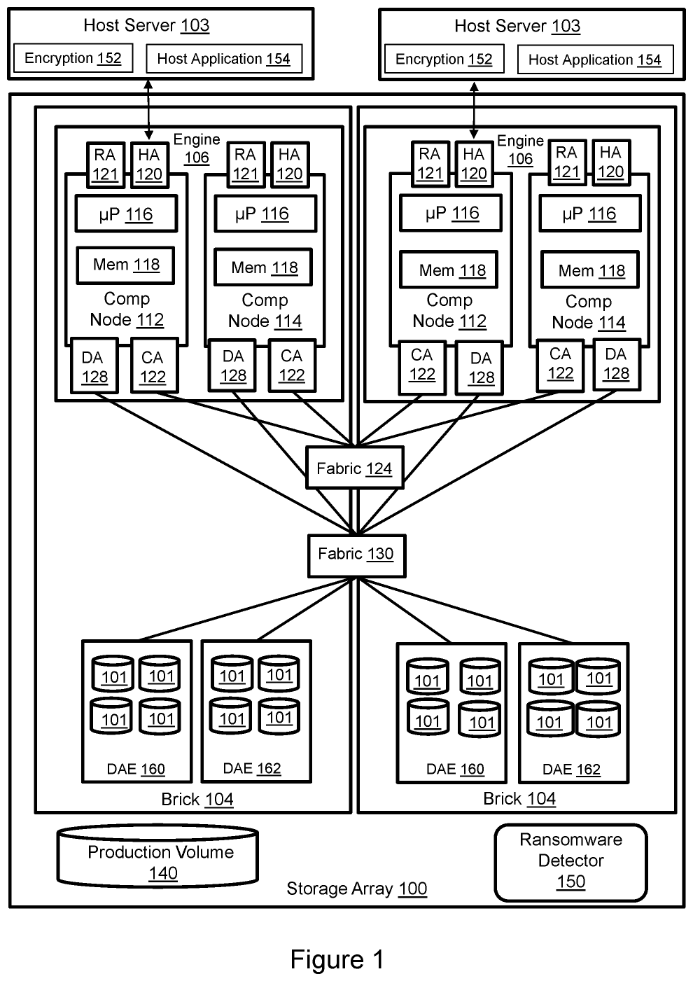

FIG. 1 illustrates a storage array 100 with a ransomware detector 150 that recognizes maliciously encrypted host application data based on variations in data reducibility in terms of compressibility, deduplicability, or both. The storage array is one example of a SAN, which is one example of a data storage system in which the ransomware detector could be implemented. The storage array 100 is depicted in a simplified data center environment supporting two host servers 103 that run host applications, but the storage array would typically support more than two host servers. The host servers 103 may include volatile memory, non-volatile storage, and one or more tangible processors that support instances of a host application 154, as is known in the art.

The storage array 100 includes one or more bricks 104. Each brick includes an engine 106 and one or more disk array enclosures (DAEs) 160, 162. Each engine 106 includes a pair of interconnected compute nodes 112, 114 that are arranged in a failover relationship and may be referred to as “storage directors.” Although it is known in the art to refer to the compute nodes of a SAN as “hosts,” that naming convention is avoided in this disclosure to help distinguish the network server hosts 103 from the compute nodes 112, 114. Nevertheless, the host applications could run on the compute nodes, e.g., on virtual machines or in containers. Each compute node includes resources such as at least one multi-core processor 116 and local memory 118. The processor may include central processing units (CPUs), graphics processing units (GPUs), or both. The local memory 118 may include volatile media such as dynamic random-access memory (DRAM), non-volatile memory (NVM) such as storage class memory (SCM), or both. Each compute node includes one or more host adapters (HAs) 120 for communicating with the host servers 103. Each host adapter has resources for servicing input-output commands (IOs) from the host servers. The host adapter resources may include processors, volatile memory, and ports via which the hosts may access the storage array. Each compute node also includes a remote adapter (RA) 121 for communicating with other storage systems, e.g., for remote mirroring, backup, and replication. Each compute node also includes one or more disk adapters (DAs) 128 for communicating with managed drives 101 in the DAEs 160, 162. Each disk adapter has processors, volatile memory, and ports via which the compute node may access the DAEs for servicing IOs. Each compute node may also include one or more channel adapters (CAs) 122 for communicating with other compute nodes via an interconnecting fabric 124. The managed drives 101 include non-volatile storage media that may be of any type, e.g., solid-state drives (SSDs) based on EEPROM technology such as NAND and NOR flash memory and hard disk drives (HDDs) with spinning disk magnetic storage media. Disk controllers may be associated with the managed drives as is known in the art. An interconnecting fabric 130 enables implementation of an N-way active-active backend. A backend connection group includes all disk adapters that can access the same drive or drives. In some implementations, every disk adapter 128 in the storage array can reach every DAE via the fabric 130. Further, in some implementations every disk adapter in the storage array can access every managed disk 101.

The host application data is maintained on the managed drives 101 of the storage array 100. The managed drives are not discoverable by the host servers 103, but the storage array 100 creates a logical storage object known as a production volume 140 that can be discovered and accessed by the host servers 103. Without limitation, the production volume may be referred to as a device, source device, production device, or production LUN, where a logical unit number (LUN) is a number used to identify logical storage volumes in accordance with the small computer system interface (SCSI) protocol. From the perspective of the host servers 103, the production volume 140 is a single disk having a set of contiguous fixed-size logical block addresses (LBAs) on which data used by the instances of the host application resides. However, the host application data is stored at non-contiguous addresses on various managed drives 101. The compute nodes maintain metadata that maps between the logical block addresses of the production volume 140 and physical addresses on the managed drives 101 in order to process IOs from the hosts. Separate production volumes may be created for each host application. Multiple instances of a single host application may use data from the same production volume.

Encryption software 152 running on the host servers 103 functions to encrypt host application data that is written to the storage array 100 and decrypt the host application data received from the storage array. Such encryption is for legitimate purposes and should not be confused with a ransomware attack. For enhanced security, portions of the host application data may be maintained in an encrypted state on the host servers, e.g., decrypted only when needed by the host server processors to support functioning of the host application 154 instances. In order to enable the storage array 100 to perform compression and/or deduplication on the host application data, the host servers or other client computers share decryption keys with the storage array. The storage array uses the keys to decrypt the host application data and then perform compression and/or deduplication on the decrypted host application data. The storage array then encrypts the compressed/deduped host application data for storage on the managed drives.

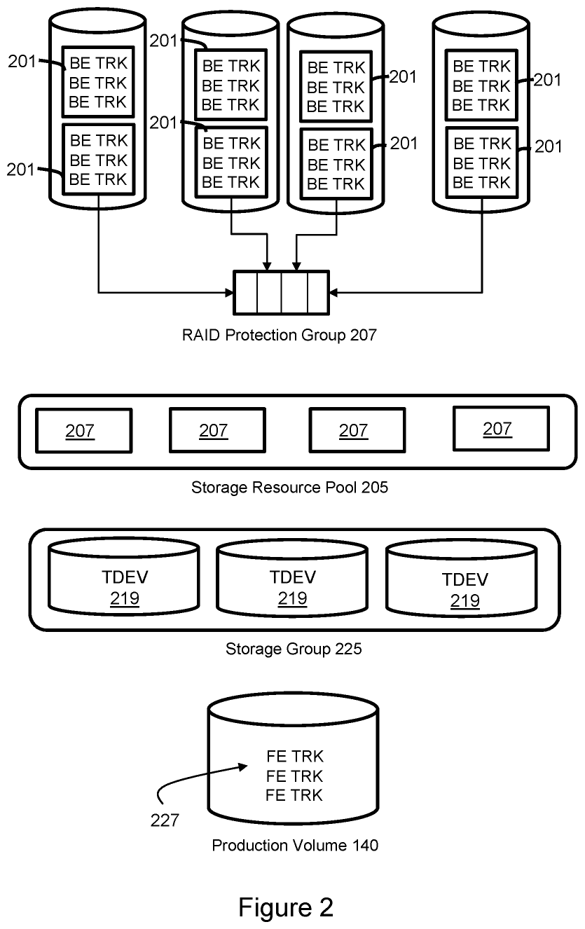

FIG. 2 illustrates layers of abstraction between clusters of the managed drives 101 and the production volume 140 in greater detail. Referring to FIGS. 1 and 2, the basic allocation unit of storage capacity that is used by the compute nodes 112, 114 to access the managed drives 101 is a back-end track (BE TRK). The managed drives may be configured with same-size partitions 201, each of which may contain multiple BE TRKs. A group of partitions from different managed drives is used to create a RAID protection group 207. More particularly, the partitions accommodate protection group members. A storage resource pool 205 is a storage object that includes a collection of RAID protection groups 207 of the same type, e.g., RAID-5 (3+1). Logical thin devices (TDEVs) 219 are storage objects created from a storage resource pool and organized into a storage group 225. The production volume 140 is created from one or more storage groups. Host application data is logically stored in front-end tracks (FE TRKs) 227, that may be referred to as blocks, on the production volume 140. The FE TRKs 227 on the production volume 140 are mapped to BE TRKs 200 of the managed drives, where the host application data is physically stored.

The ransomware detector 150 is configured to detect malicious encryption of host application data based on changes in reducibility. A compression ratio, also known as a compression power, is a measurement of relative reduction in size of data representations produced by a data compression algorithm, e.g., expressed as the division of uncompressed size by compressed size. Deduplication (dedup) ratio is a measurement of the amount of data reduction achieved by data deduplication, e.g., a 20:1 deduplication ratio means that 20 units of logical data can be stored in 1 unit of physical disk storage capacity. In general, the data generated and used by different host applications or host application types tends to exhibit different reducibility in terms of compression and dedup ratios. However, individual host applications, e.g., a particular email program, and individual storage objects, e.g., a production volume for that email program, tend to create, use, or store host application data that exhibits compression/dedup ratios within a predictable range. Moreover, compressibility and deduplicability tend to change as a result of malicious encryption. For example, maliciously encrypted data may become less compressible or have fewer redundancies that can be deduplicated. The ransomware detector is provided with, or builds, a compression/dedup ratio profile for each storage object to be protected, e.g., production volume 140. Each time new host application data is written to the protected storage object by a host server, the ransomware detector obtains the calculated compression/dedup ratio of the new host application data and compares that calculated ratio with the compression/dedup profile for the protected storage object. If the compression/dedup ratio for the new host application data deviates from the profile, e.g., in a statistically significant way, the ransomware detector prompts ransomware counter-measures and generates a ransomware attack alert message. The ransomware detector may include one or more of program code, programmed hardware, and other implementations. For example, and without limitation, the ransomware detector may include program code running on the compute nodes or electronic hardware logic integrated into the compute nodes.

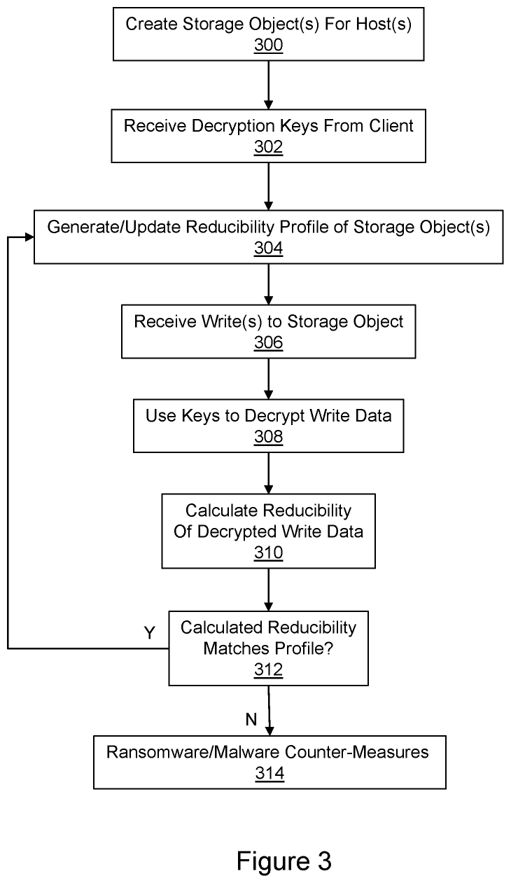

FIG. 3 illustrates a method for recognizing maliciously encrypted host application data based on variations in reducibility. The storage node creates one or more storage objects for one or more host servers as indicated in step 300. The storage objects may be production volumes that are discoverable by the host servers. Separate production volumes may be created for each host application. The storage objects are populated with encrypted host application data. The storage node receives decryption keys from the client as indicated in step 302. The client may be a host server or other computer. The decryption keys enable decryption of the host application data sent by the host servers and stored on the storage objects. The ransomware detector generates a separate data reducibility profile of each protected storage object as indicated in step 304. This may be accomplished by decrypting the host application data with the keys and performing deduplication and/or compression on the host application data. The profile may indicate a range of compression ratios, dedup ratios, or both, from different calculations. In step 306 the storage node receives IOs that write to one of the storage objects. The keys for that storage object are used to decrypt the new host application data being written to the storage object as indicated in step 308. A reducibility ratio is then calculated for the decrypted data being written as indicated in step 310. This may be accomplished by the ransomware detector monitoring or performing compression and/or deduplication on the decrypted data. Step 312 is determining whether the calculated compression and/or dedup ratio(s) match the profile of the storage object. A match may be indicated by a calculated compression and/or dedup ratio that falls within a range indicated by the profile, e.g., expressed as standard deviations from a normal distribution. In the event of a match, the IO is not indicated to be associated with a ransomware attack. The storage object profile may optionally be updated based on the new host application data as indicated by flow back to step 304. Updating the profile may help to avoid false positive ransomware attack detections for host application data that has a time-variable profile. In the event of a mismatch, the ransomware detector generates counter-measures such as halting generation or overwriting of snaps, halting replication, and halting backup of the storage object, and sending a ransomware attack alert message to the client, e.g., to the host servers. In some implementations a mismatch is indicated by a non-zero compression and/or dedup ratio in the profile and a zero or near zero calculated compression and/or dedup ratio for the new host application data.

Specific examples have been presented to provide context and convey inventive concepts. The specific examples are not to be considered as limiting. A wide variety of modifications may be made without departing from the scope of the inventive concepts described herein. Moreover, the features, aspects, and implementations described herein may be combined in any technically possible way. Accordingly, modifications and combinations are within the scope of the following claims.

What is claimed is:

1. An apparatus, comprising:
a storage node configured to logically maintain, on a storage object, data for a host application running on a host server, the data being physically maintained on non-volatile storage media, the storage node comprising a ransomware detector configured to generate a data reducibility profile of the storage object and, responsive to receipt of a command to write new data to the storage object, calculate reducibility of the new data, compare the calculated reducibility of the new data with the data reducibility profile of the storage object, and responsive to a mismatch between the calculated reducibility of the new data and the data reducibility profile of the storage object, initiate ransomware attack counter-measures.

2. The apparatus of claim 1 wherein the host server is configured to write the new data to the storage object in an encrypted state.

3. The apparatus of claim 2 wherein the storage node is configured to decrypt the new data prior to calculation of the reducibility of the new data.

4. The apparatus of claim 1 wherein the ransomware detector is configured to identify the mismatch based on a non-zero compression or deduplication ratio in the profile and a zero or near zero calculated compression or deduplication ratio for the new data.

5. The apparatus of claim 1 wherein the ransomware detector is configured to identify the mismatch based on standard deviations from a normal distribution in the profile.

6. The apparatus of claim 1 wherein the ransomware attack counter-measures comprise a ransomware attack alert message.

7. The apparatus of claim 1 wherein the ransomware attack counter-measures comprise a command to halt generation of snapshots of the storage object.

8. A method implemented by a storage node that maintains data for a host application running on a host server, comprising:
generating a data reducibility profile of a storage object on which the data is stored;
receiving a command to write new data to the storage object;
calculating reducibility of the new data;
comparing the calculated reducibility of the new data with the data reducibility profile of the storage object; and
responsive to a mismatch between the calculated reducibility of the new data and the data reducibility profile of the storage object, initiating ransomware attack counter-measures.

9. The method of claim 8 comprising the host server writing the new data to the storage object in an encrypted state.

10. The method of claim 9 comprising the storage node decrypting the new data prior to calculating reducibility of the new data.

11. The method of claim 8 comprising identifying the mismatch based on a non-zero compression or deduplication ratio in the profile and a zero or near zero calculated compression or deduplication ratio for the new data.

12. The method of claim 8 comprising identifying the mismatch based on standard deviations from a normal distribution in the profile.

13. The method of claim 8 wherein initiating ransomware attack counter-measures comprises generating a ransomware attack alert message.

14. The method of claim 8 wherein initiating ransomware attack counter-measures comprises halting generation of snapshots of the storage object.

15. A non-transitory computer-readable storage medium with instructions that, when executed by a storage node that maintains data for a host application running on a host server, cause the storage node to implement a method comprising:
generating a data reducibility profile of a storage object on which the data is stored;
receiving a command to write new data to the storage object;
calculating reducibility of the new data;
comparing the calculated reducibility of the new data with the data reducibility profile of the storage object; and
responsive to a mismatch between the calculated reducibility of the new data and the data reducibility profile of the storage object, initiating ransomware attack counter-measures.

16. The non-transitory computer-readable storage medium of claim 15 comprising the host server writing the new data to the storage object in an encrypted state.

17. The non-transitory computer-readable storage medium of claim 16 comprising the storage node decrypting the new data prior to calculating reducibility of the new data.

18. The non-transitory computer-readable storage medium of claim 15 comprising identifying the mismatch based on a non-zero compression or deduplication ratio in the profile and a zero or near zero calculated compression or deduplication ratio for the new data.

19. The non-transitory computer-readable storage medium of claim 15 identifying the mismatch based on standard deviations from a normal distribution in the profile.

20. The non-transitory computer-readable storage medium of claim 15 wherein initiating ransomware attack counter-measures comprises generating a ransomware attack alert message.
